(19) United States
(12) Patent Application Publication
(10) Pub. No.: US 2025/0235757 A1
(43) Pub. Date: Jul. 24, 2025

(54) GRIP RUBBER COMPOSITION AND GOLF CLUB GRIP

(71) Applicant: Sumitomo Rubber Industries, Ltd., Kobe-shi (JP)

(72) Inventors: Sho GOJI, Kobe-shi (JP); Kazuyoshi SHIGA, Kobe-shi (JP)

(73) Assignee: Sumitomo Rubber Industries, Ltd., Kobe-shi (JP)

(21) Appl. No.: 19/008,186

(22) Filed: Jan. 2, 2025

(30) Foreign Application Priority Data
Jan. 22, 2024 (JP) 2024-007416

(51) Int. Cl. A63B 53/14; C08K 5/40; C08K 5/405; C08K 5/44

(52) U.S. Cl. CPC A63B 53/14; C08K 5/40; C08K 5/405; C08K 5/44

(57) ABSTRACT

An object of the present disclosure is to provide a rubber composition which comprises a hydrogenated carboxy-modified acrylonitrile-butadiene rubber as a base rubber and from which a crosslinked rubber having excellent mechanical strength and a great friction coefficient is obtained even if the rubber composition is vulcanized at a high temperature. The present disclosure provides a grip rubber composition comprising a base rubber, a vulcanizing agent and a vulcanization accelerator, wherein the base rubber contains a hydrogenated carboxy-modified acrylonitrile-butadiene rubber, the rubber composition comprises a thiuram based vulcanization accelerator in an amount of 4 parts by mass or more, a sulfenamide based vulcanization accelerator in an amount of 0.3 part by mass or more, and a thiourea based vulcanization accelerator in an amount of 0.1 part by mass or more with respect to 100 parts by mass of the base rubber, and a crosslinked rubber obtained by curing the rubber composition at a vulcanizing temperature of 185° C. has a loss coefficient (tan δ) and a complex elastic modulus (E*) (MPa) at a temperature of 25° C. in a ratio (tan δ/E*) ranging from 0.027 to 0.052, wherein the loss coefficient (tan δ) and the complex elastic modulus (E*) (MPa) at the temperature of 25° C. are measured with a dynamic viscoelasticity measuring apparatus (an oscillation frequency: 10 Hz, a strain amplitude: 0.05%, and a tensile mode).

### FIELD OF THE DISCLOSURE

The present disclosure relates to a grip rubber composition used for producing a grip.

### DESCRIPTION OF THE RELATED ART

As a grip (anti-slip member) provided on sporting goods or the like, a grip made of a rubber is frequently utilized. Use of a hydrogenated carboxy-modified acrylonitrile-butadiene rubber as a base rubber in such a grip has been proposed.

For example, JP 2017-113388 A discloses a grip for sporting goods comprising an outermost surface layer formed from a surface layer rubber composition, wherein the surface layer rubber composition contains (A) a base rubber and (B) a resin having a softening point in a range from 5° C. to 120° C., (A) the base rubber contains an acrylonitrile-butadiene based rubber, and (B) the resin is at least one member selected from the group consisting of a hydrogenated rosin ester, a disproportionated rosin ester, an ethylene-vinyl acetate copolymer, a coumarone resin, a phenol resin, a xylene resin and a styrene resin.

### SUMMARY OF THE DISCLOSURE

The hydrogenated carboxy-modified acrylonitrile-butadiene rubber has properties such as weather resistance and ozone resistance because the hydrogenated carboxy-modified acrylonitrile-butadiene rubber has a small amount of an unsaturated bond. However, on the other hand, there is a problem that the vulcanizing speed is slow and the productivity of the crosslinked rubber is low due to the small amount of the unsaturated bond.

Herein, a method for increasing the vulcanizing speed of the rubber composition generally includes a method of increasing the vulcanizing temperature. However, the vulcanization at the high temperature tends to lower the mechanical strength of the obtained crosslinked rubber.

In addition, the grip provided on sporting goods or the like is required to have excellent anti-slipping performance. The anti-slipping performance of the grip can also be enhanced by forming a groove pattern on the surface of the grip, but it is preferable that the rubber composition itself used for forming the grip has a high friction coefficient.

The present disclosure has been made in view of the above circumstances, and an object of the present disclosure is to provide a rubber composition which comprises a hydrogenated carboxy-modified acrylonitrile-butadiene rubber as a base rubber and provides a crosslinked rubber having excellent mechanical strength and a high friction coefficient, even if the rubber composition is vulcanized at a high temperature.

The present disclosure that has solved the above problem provides a grip rubber composition comprising a base rubber, a vulcanizing agent and a vulcanization accelerator, wherein the base rubber contains a hydrogenated carboxy-modified acrylonitrile-butadiene rubber, the vulcanization accelerator contains a thiuram based vulcanization accelerator, a sulfenamide based vulcanization accelerator, and a thiourea based vulcanization accelerator, an amount of the thiuram based vulcanization accelerator is 4 parts by mass or more with respect to 100 parts by mass of the base rubber, an amount of the sulfenamide based vulcanization accelerator is 0.3 part by mass or more with respect to 100 parts by mass of the base rubber, an amount of the thiourea based vulcanization accelerator is 0.1 part by mass or more with respect to 100 parts by mass of the base rubber, and a crosslinked rubber obtained by curing the grip rubber composition at a vulcanizing temperature of 185° C. has a loss coefficient (tan δ) and a complex elastic modulus (E*) (MPa) at a temperature of 25° C. in a ratio (tan δ/E*) ranging from 0.027 to 0.052, wherein the loss coefficient (tan δ) and the complex elastic modulus (E*) (MPa) at the temperature of 25° C. are measured with a dynamic viscoelasticity measuring apparatus under measuring conditions of an oscillation frequency: 10 Hz, a strain amplitude: 0.05%, and a tensile mode.

Even if the grip rubber composition according to the present disclosure is vulcanized at a high temperature, a crosslinked rubber having excellent mechanical strength and a high friction coefficient is obtained. Thus, the vulcanizing temperature can be set high for forming the grip to shorten the vulcanizing time. As a result, the productivity of the grip is improved.

If the grip rubber composition according to the present disclosure is used, a grip having excellent mechanical strength and excellent anti-slipping performance can be obtained, and the productivity of the grip can be improved.

### BRIEF DESCRIPTION OF THE DRAWINGS

FIG. 1 is a perspective view showing one example of a golf club grip according to the present disclosure, and

FIG. 2 is a perspective view showing one example of a golf club comprising a golf club grip according to the present disclosure.

### DESCRIPTION OF THE PREFERRED EMBODIMENT

### [Rubber Composition]

The grip rubber composition (hereinafter sometimes simply referred to as “rubber composition”) of the present disclosure is used to form a grip.

The rubber composition comprises a base rubber, a vulcanizing agent and a vulcanization accelerator, the base rubber contains a hydrogenated carboxy-modified acrylonitrile-butadiene rubber, the vulcanization accelerator contains a thiuram based vulcanization accelerator, a sulfenamide based vulcanization accelerator, and a thiourea based vulcanization accelerator, an amount of the thiuram based vulcanization accelerator is 4 parts by mass or more with respect to 100 parts by mass of the base rubber, an amount of the sulfenamide based vulcanization accelerator is 0.3 part by mass or more with respect to 100 parts by mass of the base rubber, and an amount of the thiourea based vulcanization accelerator is 0.1 part by mass or more with respect to 100 parts by mass of the base rubber.

Further, a crosslinked rubber obtained by curing the rubber composition at a vulcanizing temperature of 185° C. has a loss coefficient (tan δ) and a complex elastic modulus (E*) (MPa) at a temperature of 25° C. in a ratio (tan δ/E*) ranging from 0.027 to 0.052, wherein the loss coefficient (tan δ) and the complex elastic modulus (E*) (MPa) at the temperature of 25° C. are measured with a dynamic viscoelasticity measuring apparatus under measuring conditions of an oscillation frequency: 10 Hz, a strain amplitude: 0.05%, and a tensile mode.

Blending the thiuram based vulcanization accelerator, the sulfenamide based vulcanization accelerator and the thiourea based vulcanization accelerator as the vulcanization accelerator in an predetermined amount in the rubber composition containing the hydrogenated carboxy-modified acrylonitrile-butadiene rubber as the base rubber provides a crosslinked rubber having excellent mechanical strength, even if the rubber composition is vulcanized at a high temperature.

The reason why the mechanical strength of the crosslinked rubber obtained by vulcanizing the rubber composition at a high temperature is not lowered is not clear, but it is considered as follows. Elevating the vulcanizing temperature when vulcanizing the hydrogenated carboxy-modified acrylonitrile-butadiene rubber which has a small amount of the unsaturated bond causes to increase generation of intramolecular crosslinking and so-called pendants, which are not the crosslinking points. So-called pendants mean that the crosslinking precursor of the vulcanization accelerator hangs from the rubber chain. Thus, it is considered that the crosslinked density is lowered, and the strength of the crosslinked rubber is lowered. In the grip rubber composition according to the present disclosure, the thiuram based vulcanization accelerator, the sulfenamide based vulcanization accelerator, and the thiourea based vulcanization accelerator are used in combination, and these vulcanization accelerators activate each other to increase the vulcanizing speed. As a result, it is considered that even if the rubber composition is vulcanized at a high temperature, formation of the intramolecular crosslinking and the pendants that cause the lowering in the crosslinked density and the strength can be lowered, and the lowering in the mechanical strength associated with the lowering of the crosslinked density can be prevented.

If the loss tangent (tan δ) of the crosslinked rubber at the temperature of 25° C. is great, the lost energy during deformation is great, and thus the hysteresis friction is great. In addition, if the complex elastic modulus (E*) (MPa) of the crosslinked rubber at the temperature of 25° C. is greater (the crosslinked rubber is hard), it is more disadvantageous to the friction. Thus, it is considered that, if their ratio (tan δ/E*) is 0.027 or more, the hysteresis loss is great, and the friction coefficient of the crosslinked rubber improves, and if their ratio (tan δ/E*) is 0.052 or less, occurrence of poor dispersion is prevented, and the friction coefficient of the crosslinked rubber improves.

### (Base Rubber)

The rubber composition comprises a base rubber. The amount of the base rubber in the rubber composition is preferably 50 mass % or more, more preferably 55 mass % or more.

The base rubber contains a hydrogenated carboxy-modified acrylonitrile-butadiene rubber (hereinafter sometimes referred to as “HXNBR”). The HXNBR is a hydrogenated product of a copolymer of a monomer having a carboxy group, acrylonitrile and butadiene. It is noted that the HXNBR may be used solely, or two or more of them may be used in combination.

The amount of the acrylonitrile in the HXNBR is preferably 15 mass % or more, more preferably 18 mass % or more, and even more preferably 21 mass % or more, and is preferably 50 mass % or less, more preferably 45 mass % or less, and even more preferably 40 mass % or less. If the amount of the acrylonitrile is 15 mass % or more, the grip has better abrasion resistance, and if the amount of the acrylonitrile is 50 mass % or less, the grip has a better touch feeling in a cold region or in winter.

Examples of the monomer having the carboxy group in the HXNBR include acrylic acid, methacrylic acid, fumaric acid, and maleic acid. The amount of the monomer having the carboxy group in the HXNBR is preferably 1.0 mass % or more, more preferably 2.0 mass % or more, and even more preferably 3.5 mass % or more, and is preferably 30 mass % or less, more preferably 25 mass % or less, and even more preferably 20 mass % or less. If the amount of the monomer having the carboxy group is 1.0 mass % or more, the grip has better abrasion resistance, and if the amount of the monomer having the carboxy group is 30 mass % or less, the grip has a better touch feeling in a cold region or in winter.

The amount of the carboxy group in the HXNBR is preferably 1.0 mass % or more, more preferably 2.0 mass % or more, and even more preferably 3.5 mass % or more, and is preferably 30 mass % or less, more preferably 25 mass % or less, and even more preferably 20 mass % or less. If the amount of the carboxy group is 1.0 mass % or more, the grip has better abrasion resistance, and if the amount of the carboxy group is 30 mass % or less, the grip has a better touch feeling in a cold region or in winter.

The amount of the double bond in the HXNBR is preferably 0.09 mmol/g or more, more preferably 0.2 mmol/g or more, and is preferably 2.5 mmol/g or less, more preferably 2.0 mmol/g or less, and even more preferably 1.5 mmol/g or less. If the amount of the double bond is 0.09 mmol/g or more, vulcanization is easily carried out during molding, and the grip has further enhanced tensile strength, and if the amount of the double bond is 2.5 mmol/g or less, the grip has better durability (weather resistance) and tensile strength. The amount of the double bond can be adjusted by the amount of butadiene in the copolymer or the amount of hydrogen added into the copolymer.

The amount of the HXNBR in the base rubber is preferably 50 mass % or more, more preferably 70 mass % or more, and even more preferably 90 mass % or more. In addition, it is also preferable that the base rubber of the rubber composition consists of the HXNBR. If the amount of the HXNBR in the base rubber is higher, the abrasion resistance, durability (weather resistance) and tensile strength of the obtained grip is better.

The base rubber may contain other rubber components than the HXNBR, as long as the other rubber components do not impair the effect of the present disclosure. Examples of the other rubber components include a natural rubber (NR), an ethylene-propylene-diene rubber (EPDM), a butyl rubber (IIR), an acrylonitrile-butadiene rubber (NBR), a hydrogenated acrylonitrile-butadiene rubber (HNBR), a carboxy-modified acrylonitrile-butadiene rubber (XNBR), a butadiene rubber (BR), a styrene-butadiene rubber (SBR), a polyurethane rubber (PU), an isoprene rubber (IR), a chloroprene rubber (CR), and an ethylene-propylene rubber (EPM). These base rubbers may be used solely, or two or more of them may be used in combination.

### (Vulcanizing Agent)

As the vulcanizing agent, a sulfur vulcanizing agent and an organic peroxide can be used. The vulcanizing agent may be used solely, or two or more of them may be used in combination.

Examples of the sulfur vulcanizing agent include an elemental sulfur and a sulfur donor type compound. Examples of the elemental sulfur include powdery sulfur, precipitated sulfur, colloidal sulfur, and insoluble sulfur. Examples of the sulfur donor type compound include 4,4′-dithiobismorpholine.

Examples of the organic peroxide include dicumyl peroxide, α,α′-bis(t-butylperoxy-m-diisopropyl) benzene, 2,5-dimethyl-2,5-di(t-butylperoxy) hexane, and 1,1-bis(t-butylperoxy)-3,3,5-trimethylcyclohexane.

As the vulcanizing agent, the sulfur vulcanizing agent is preferable, and the elemental sulfur is more preferable. If the sulfur vulcanizing agent is used as the vulcanizing agent, the mechanical strength of the obtained crosslinked rubber tends to be enhanced. In addition, if the sulfur vulcanizing agent is used, the binding energy between the rubber chains is not high, the hysteresis loss during deformation is great, and the friction coefficient improves.

The amount of the vulcanizing agent is preferably 0.2 part by mass or more, more preferably 0.4 part by mass or more, and even more preferably 0.6 part by mass or more, and is preferably 4.0 parts by mass or less, more preferably 3.5 parts by mass or less, and even more preferably 3.0 parts by mass or less, with respect to 100 parts by mass of the base rubber. If the amount of the vulcanizing agent is 0.2 part by mass or more, vulcanization more easily proceeds, and if the amount of the vulcanizing agent is 4.0 parts by mass or less, occurrence of scorch can be lowered.

### (Vulcanization Accelerator)

The rubber composition comprises a thiuram based vulcanization accelerator, a sulfenamide based vulcanization accelerator and a thiourea based vulcanization accelerator in a predetermined amount, respectively, as a vulcanization accelerator. If the thiuram based vulcanization accelerator and the sulfenamide based vulcanization accelerator are used in combination, a crosslinked rubber having excellent mechanical strength can be obtained, even if the rubber composition is vulcanized at a high temperature.

### Thiuram Based Vulcanization Accelerator

Examples of the thiuram based vulcanization accelerator include tetramethylthiuram disulfide (TMTD), tetrabenzylthiuram disulfide (TBzTD), tetramethylthiuram monosulfide (TMTM), dipentamethylene thiuram tetrasulfide, and tetrakis(2-ethylhexyl)thiuram disulfide. The thiuram based vulcanization accelerator may be used solely, but two or more of them are preferably used in combination from the viewpoint of anti-blooming.

The amount of the thiuram based vulcanization accelerator is preferably 4 parts by mass or more, more preferably 5 parts by mass or more, and even more preferably 6 parts by mass or more, and is preferably 9 parts by mass or less, more preferably 8 parts by mass or less, and even more preferably 7 parts by mass or less, with respect to 100 parts by mass of the base rubber. If the amount of the thiuram based vulcanization accelerator falls within the above range, much faster vulcanization can be achieved while maintaining the anti-scorching property, even if the base rubber has a small amount of the double bond.

### Sulfenamide Based Vulcanization Accelerator

Examples of the sulfenamide based vulcanization accelerator include N-cyclohexyl-2-benzothiazolyl sulfenamide (CBS), and N-(tert-butyl)-2-benzothiazole sulfenamide (BBS). The sulfenamide based vulcanization accelerator may be solely used, or two or more of them may be used in combination.

The amount of the sulfenamide based vulcanization accelerator is preferably 0.3 part by mass or more, more preferably 0.5 part by mass or more, and even more preferably 0.7 part by mass or more, and is preferably 2.5 parts by mass or less, more preferably 2.0 parts by mass or less, and even more preferably 1.5 parts by mass or less, with respect to 100 parts by mass of the base rubber. If the amount of the sulfenamide based vulcanization accelerator falls within the above range, occurrence of blooming can be further lowered.

### Thiourea Based Vulcanization Accelerator

Examples of the thiourea based vulcanization accelerator include trimethylthiourea, and N,N′-diethylthiourea. The thiourea based vulcanization accelerator may be solely used, or two or more of them may be used in combination.

The amount of the thiourea based vulcanization accelerator is preferably 0.1 part by mass or more, more preferably 0.2 part by mass or more, and even more preferably 0.3 part by mass or more, and is preferably 1.0 part by mass or less, more preferably 0.8 part by mass or less, and even more preferably 0.6 part by mass or less, with respect to 100 parts by mass of the base rubber. If the amount of the thiourea based vulcanization accelerator falls within the above range, the thiuram based vulcanization accelerator is activated, and the vulcanizing time can be further shortened.

The total amount of the thiuram based vulcanization accelerator, the sulfenamide based vulcanization accelerator and the thiourea based vulcanization accelerator in the rubber composition is preferably 4.4 parts by mass or more, more preferably 5.4 parts by mass or more, and even more preferably 6.4 parts by mass or more, and is preferably 12.5 parts by mass or less, more preferably 10.5 parts by mass or less, and even more preferably 9.5 parts by mass or less, with respect to 100 parts by mass of the base rubber. If the total amount is 4.4 parts by mass or more, the vulcanizing speed can be further increased, even if the base rubber has a small amount of the double bond, and if the total amount is 12.5 parts by mass or less, the rubber has better anti-scorching property when the rubber has a small amount of the double bond.

The mass ratio (thiuram based vulcanization accelerator/sulfenamide based vulcanization accelerator) of the thiuram based vulcanization accelerator to the sulfenamide based vulcanization accelerator in the rubber composition is preferably 1.5 or more, more preferably 3.0 or more, and even more preferably 4.5 or more, and is preferably 30 or less, more preferably 20 or less, and even more preferably 10 or less. If the mass ratio (thiuram based vulcanization accelerator/sulfenamide based vulcanization accelerator) is 1.5 or more, the vulcanizing speed can be further increased, even if the base rubber has a small amount of the double bond, and if the mass ratio (thiuram based vulcanization accelerator/sulfenamide based vulcanization accelerator) is 30 or less, lowering in the strength of the crosslinked rubber obtained under vulcanization conditions of a high temperature and a high speed can be further controlled.

The mass ratio (thiuram based vulcanization accelerator/thiourea based vulcanization accelerator) of the thiuram based vulcanization accelerator to the thiourea based vulcanization accelerator in the rubber composition is preferably 4 or more, more preferably 6 or more, and even more preferably 8 or more, and is preferably 20 or less, more preferably 18 or less, and even more preferably 16 or less. If the mass ratio (thiuram based vulcanization accelerator/thiourea based vulcanization accelerator) is 4 or more, the obtained crosslinked rubber has further enhanced strength, and if the mass ratio (thiuram based vulcanization accelerator/thiourea based vulcanization accelerator) is 20 or less, activation of the thiuram based accelerator by the thiourea based accelerator is further enhanced.

The rubber composition may comprise other vulcanization accelerators, as long as the other vulcanization accelerators do not impair the effect of the present disclosure. Examples of the other vulcanization accelerators include a thiazole based vulcanization accelerator such as mercaptobenzothiazole (MBT) and benzothiazole disulfide; a guanidine based vulcanization accelerator such as diphenylguanidine (DPG); and a dithiocarbamate based vulcanization accelerator such as zinc dimethyldithiocarbamate (ZnPDC) and zinc dibutyldithiocarbamate.

The total amount of the vulcanization accelerators in the base rubber is preferably 4.4 parts by mass or more, more preferably 5.4 parts by mass or more, and even more preferably 6.4 parts by mass or more, and is preferably 12.5 parts by mass or less, more preferably 10.5 parts by mass or less, and even more preferably 8.5 parts by mass or less, with respect to 100 parts by mass of the base rubber. If the total amount of the vulcanization accelerators falls within the above range, occurrence of blooming or the like can be further suppressed.

### (Vulcanization Activator)

The rubber composition may further comprise a vulcanization activator.

Examples of the vulcanization activator include a metal oxide, a metal peroxide, and a fatty acid. Examples of the metal oxide include zinc oxide, magnesium oxide, and lead oxide. Examples of the metal peroxide include zinc peroxide, chrome peroxide, magnesium peroxide, and calcium peroxide. Examples of the fatty acid include stearic acid, oleic acid, and palmitic acid. These vulcanization activators may be solely used, or two or more of them may be used in combination.

The total amount of the vulcanization activator is preferably 0.5 part by mass or more, more preferably 0.6 part by mass or more, and even more preferably 0.7 part by mass or more, and is preferably 10.0 parts by mass or less, more preferably 9.5 parts by mass or less, and even more preferably 9.0 parts by mass or less, with respect to 100 parts by mass of the base rubber.

(Thermoplastic Resin) The rubber composition may further comprise a thermoplastic resin (excluding tackifier). If the thermoplastic resin is comprised, the viscoelastic properties of the cured product of the rubber composition can be controlled, and the feeling can be enhanced.

When the rubber composition comprises the thermoplastic resin, the amount of the thermoplastic resin is preferably 5 parts by mass or more, more preferably 7 parts by mass or more, and even more preferably 9 parts by mass or more, and is preferably 40 parts by mass or less, more preferably 38 parts by mass or less, and even more preferably 36 parts by mass or less, with respect to 100 parts by mass of the base rubber. If the amount of the thermoplastic resin is 5 parts by mass or more, the obtained grip has a further enhanced friction coefficient, and if the amount of the thermoplastic resin is 40 parts by mass or less, lowering in the strength of the cured product of the rubber composition is suppressed.

Examples of the thermoplastic resin include an ethylene-vinyl acetate copolymer, and a styrene based elastomer.

The amount of the vinyl acetate in the ethylene-vinyl acetate copolymer is preferably 10 mass % or more, more preferably 12 mass % or more, and even more preferably 15 mass % or more, and is preferably 80 mass % or less, more preferably 75 mass % or less, and even more preferably 70 mass % or less. If the amount of the vinyl acetate is 10 mass % or more, the grip has better feeling, and if the amount of the vinyl acetate is 80 mass % or less, the grip has further enhanced abrasion resistance.

The Mooney viscosity (ML₁₊₄ (100° C.)) of the ethylene-vinyl acetate copolymer is preferably 20 or more, more preferably 22 or more, and even more preferably 24 or more, and is preferably 40 or less, more preferably 38 or less, and even more preferably 36 or less. It is noted that the Mooney viscosity (ML₁₊₄ (100° C.)) in the present disclosure is a value measured according to ISO289 using an L rotor under the conditions of: a preheating time of 1 minute; a rotor revolution time of 4 minutes; and a temperature of 100° C.

Examples of the styrene based elastomer include a styrene-butadiene-styrene block copolymer (SBS), a styrene-isobutylene-styrene block copolymer (SIBS), and a styrene-ethylene-butylene-styrene block copolymer (SEBS).

### (Reinforcing Material)

Examples of the reinforcing material include carbon black, silica, and calcium carbonate. In addition, if the reinforcing material is comprised, the density of the crosslinked rubber can be adjusted, and the mass of the grip formed from the rubber composition can be adjusted.

The specific surface area of the reinforcing material preferably ranges from 1 m²/g to 300 m²/g.

When the rubber composition comprises the reinforcing material, the amount of the reinforcing material is preferably 9 parts by mass or more, more preferably 14 parts by mass or more, and even more preferably 19 parts by mass or more, and is preferably 36 parts by mass or less, more preferably 30 parts by mass or less, and even more preferably 24 parts by mass or less, with respect to 100 parts by mass of the base rubber. If the amount of the reinforcing material falls within the above range, the mass of the obtained grip is easily controlled in the desired range.

### (Tackifier)

The rubber composition may further comprise a tackifier. When a large amount of the reinforcing material is comprised in the rubber composition to adjust the density of the crosslinked rubber, the ratio (tan δ/E*) of the crosslinked rubber tends to become great, but if the tackifier is comprised, the ratio (tan δ/E*) can be lowered.

It is noted that when the tackifier is comprised, the time required to vulcanize the rubber composition tends to become long. However, since the rubber composition according to the present disclosure comprises the predetermined amounts of the thiuram based vulcanization accelerator, the sulfenamide based vulcanization accelerator and the thiourea based vulcanization accelerator as the vulcanization accelerator, the rubber composition can be vulcanized in a short time, even if it comprises the tackifier.

Examples of the tackifier include a rosin ester, a coumarone resin, a phenol resin, a terpene resin, a terpene phenol resin, and a styrene based resin.

The rosin ester is an ester compound obtained by a reaction between a rosin and an alcohol. The rosin is a natural resin containing abietic acid, neoabietic acid, palustric acid, pimaric acid, isopimaric acid, and dehydroabietic acid. Examples of the alcohol include a monohydric alcohol such as n-octyl alcohol, 2-ethylhexyl alcohol, decyl alcohol, lauryl alcohol and stearyl alcohol; a dihydric alcohol such as ethylene glycol, diethylene glycol, polyethylene glycol, propylene glycol, dipropylene glycol, polypropylene glycol and neopentyl glycol; a trihydric alcohol such as glycerin and trimethylolpropane; a tetrahydric alcohol such as pentaerythritol and diglycerin; and a hexahydric alcohol such as dipentaerythritol and sorbitol. Among them, the polyhydric alcohol such as the dihydric alcohol or higher alcohol is preferable, and glycerin is more preferable.

The rosin ester includes a hydrogenated rosin ester and a disproportionated rosin ester. The hydrogenated rosin ester and the disproportionated rosin ester are so-called stabilized rosin esters.

The hydrogenated rosin ester is an ester compound having at least one part of the moiety derived from the rosin of the rosin ester being hydrogenated. The hydrogenated rosin ester may be obtained by a method of hydrogenating the rosin followed by carrying out a reaction between the obtained hydrogenated rosin and an alcohol, or a method of carrying out a reaction between the rosin and an alcohol followed by hydrogenating the obtained rosin ester.

The disproportionated rosin ester is an ester compound having at least one part of the moiety derived from the rosin of the rosin ester being disproportionated. The disproportionated rosin ester may be obtained by a method of disproportionating the rosin followed by carrying out a reaction between the obtained disproportionated rosin and an alcohol, or a method of carrying out a reaction between the rosin and an alcohol followed by disproportionating the obtained rosin ester.

The coumarone resin is a resin including a coumarone-based compound as a monomer component. The coumarone resin is preferably a coumarone-indene resin. The coumarone-indene resin is a copolymer including, as a monomer component, a coumarone-based compound and an indene-based compound, in a total amount of 50 mass % or more in all the monomer components. Examples of the coumarone-based compound include coumarone, and methyl coumarone. The amount of the coumarone-based compound in all the monomer components preferably ranges from 1 mass % to 20 mass %. Examples of the indene-based compound include indene, and methy lindene. The amount of the indene-based compound in all the monomer components preferably ranges from 40 mass % to 95 mass %. The coumarone-indene resin may further include other monomer components than the coumarone-based compound and the indene-based compound. Examples of the other monomer components include styrene, vinyl toluene, and dicyclopentadiene.

Examples of the phenol resin include a condensation product of a phenol-based compound and formaldehyde. Examples of the phenol-based compound include phenol, and m-cresol. In addition, examples of the phenol resin include a resol obtained by an addition reaction between the phenol-based compound and the formaldehyde in the presence of an alkaline catalyst; and a novolac obtained by a condensation reaction between the phenol-based compound and the formaldehyde in the presence of an acid catalyst. Examples of the phenol resin further include a rosin phenol resin obtained by an addition reaction and a thermal polymerization reaction between the phenol-based compound and a rosin in the presence of an acid catalyst.

When the rubber composition comprises the tackifier, the amount of the tackifier is preferably 5 parts by mass or more, more preferably 6 parts by mass or more, and even more preferably 7 parts by mass or more, and is preferably 20 parts by mass or less, more preferably 19 parts by mass or less, and even more preferably 18 parts by mass or less, with respect to 100 parts by mass of the base rubber. If the amount of the tackifier is 5 parts by mass or more, the obtained grip has better feeling, and if the amount of the tackifier is 20 parts by mass or less, lowering in the mechanical strength of the cured product of the rubber composition is controlled.

### (Processing Aid)

The rubber composition also preferably comprises a processing aid. Examples of the processing aid include an internal lubricant and an external lubricant.

Examples of the internal lubricant include a mineral oil and a plasticizer. Examples of the mineral oil include a paraffin oil, a naphthene oil, and an aromatic oil. Examples of the plasticizer include dioctyl phthalate, dibutyl phthalate, dioctyl sebacate, and dioctyl adipate.

Examples of the external lubricant include a phosphoric ester compound and a long-chain alkyl amine compound.

The rubber composition preferably comprises the phosphoric ester compound as the external lubricant. If the phosphoric ester compound is comprised as the external lubricant, adhesion to an inside of the equipment during the kneading can be prevented, even if a small amount of the phosphoric ester compound is comprised, and a homogeneous rubber composition can be obtained.

When the rubber composition comprises the external lubricant, the amount of the external lubricant is preferably 0.1 part by mass or more, more preferably 0.15 part by mass or more, and even more preferably 0.25 part by mass or more, and is preferably 1.0 part by mass or less, more preferably 0.75 part by mass or less, and even more preferably 0.5 part by mass or less, with respect to 100 parts by mass of the base rubber. If the amount of the external lubricant falls within the above range, the effect of the lubricant is high, and occurrence of blooming can be controlled.

The rubber composition may further comprise an antioxidant, an anti-scorching agent, a coloring agent, or the like, where necessary.

Examples of the antioxidant include imidazoles, amines, phenols and thioureas. Examples of the imidazoles include nickel dibutyldithiocarbamate (NDIBC), 2-mercaptobenzimidazole, and zinc salt of 2-mercaptobenzimidazole. Examples of the amines include phenyl-α-napthylamine. Examples of the phenols include 2,2′-methylene bis(4-methyl-6-t-butylphenol) (MBMBP), and 2,6-di-tert-butyl-4-methylphenol. Examples of the thioureas include tributyl thiourea, and 1,3-bis(dimethylaminopropyl)-2-thiourea. These antioxidants may be used solely, or two or more of them may be used in combination.

When the rubber composition comprises the antioxidant, the amount of the antioxidant is preferably 0.2 part by mass or more, more preferably 0.3 part by mass or more, and even more preferably 0.4 part by mass or more, and is preferably 5.0 parts by mass or less, more preferably 4.8 parts by mass or less, and even more preferably 4.6 parts by mass or less, with respect to 100 parts by mass of the base rubber.

Examples of the anti-scorching agent include an organic acid and a nitroso compound. Examples of the organic acid include phthalic anhydride, pyromellitic anhydride, trimellitic anhydride, benzoic acid, salicylic acid, and malic acid. Examples of the nitroso compound include N-nitrosodiphenylamine, N-(cyclohexylthio)phthalimide, sulfonamide derivative, diphenyl urea, bis(tridecyl)pentaerythritol diphosphite, and 2-mercaptobenzimidazole.

Examples of the coloring agent include an inorganic pigment and an organic pigment. Examples of the inorganic pigment include titanium oxide, and a rutile type titanium oxide is particularly preferable from the viewpoint of high opacity. Examples of the organic pigment include an azo pigment and a phthalocyanine pigment.

The rubber composition may comprise microballoons. If the microballoons are comprised in the rubber composition, a porous grip is obtained. As the microballoons, organic microballoons or inorganic microballoons can be used. Examples of the organic microballoons include hollow particles formed from a thermoplastic resin, and resin capsules encapsulating a hydrocarbon having a low boiling point in a shell formed from a thermoplastic resin.

The rubber composition may be prepared by a conventional method. For example, the rubber composition may be prepared by kneading materials with a kneading machine such as a Banbury mixer, a kneader and an open roll. It is noted that when the rubber composition comprises the microballoons, other components than the microballoons are preferably kneaded in advance followed by kneading the kneaded product and the microballoons. The material temperature when kneading the kneaded product and the microballoons is preferably set at a temperature lower than the expansion stating temperature of the microballoons.

### (Vulcanization Characteristics)

The 90% vulcanizing time (t90) on the vulcanization curve of the rubber composition measured at the vulcanizing temperature of 185° C. is preferably 5 minutes or less, more preferably 4.5 minutes or less, and even more preferably 4 minutes or less. If the 90% vulcanizing time is 5 minutes or less, the grip can be produced in the similar cycles as the grip that comprises a base rubber having a large amount of the unsaturated bond such as the natural rubber, and the productivity is high. The lower limit of the 90% vulcanizing time is not particularly limited, and is generally 3 minutes.

The 90% vulcanizing time is obtained from the vulcanization curve measured at the vulcanizing temperature of 185° C. Specifically, when a minimum value of the torque on the vulcanization curve is ML, a maximum value of the torque on the vulcanization curve is MH, and a difference between them is ME, then the time required by the torque to become ML+90% ME is the 90% vulcanizing time.

### (Crosslinked Rubber)

A crosslinked rubber obtained by curing the rubber composition at a vulcanizing temperature of 185° C. preferably has the properties described later. It is noted that the vulcanizing time when vulcanizing the rubber composition is a time of adding 2 minutes to the 90% vulcanizing time (t90) on the vulcanization curve.

A ratio (tan δ/E*) of a loss coefficient (tan δ) to a complex elastic modulus (E*) (MPa) at a temperature of 25° C. of the crosslinked rubber obtained by curing the rubber composition at the vulcanizing temperature of 185° C. is 0.027 or more, preferably 0.030 or more, and more preferably 0.033 or more, and is 0.052 or less, preferably 0.050 or less, and more preferably 0.048 or less, wherein the loss coefficient (tan δ) and the complex elastic modulus (E*) (MPa) at the temperature of 25° C. are measured with a dynamic viscoelasticity measuring apparatus under measuring conditions of an oscillation frequency: 10 Hz, a strain amplitude: 0.05%, and a tensile mode.

The loss tangent (tan δ) at the temperature of 25° C. of the crosslinked rubber obtained by curing the rubber composition at the vulcanizing temperature of 185° C. is preferably 0.10 or more, more preferably 0.12 or more, and even more preferably 0.14 or more, wherein the loss tangent (tan δ) at the temperature of 25° C. is measured with the dynamic viscoelasticity measuring apparatus under measuring conditions of the oscillation frequency: 10 Hz, the strain amplitude: 0.05%, and the tensile mode. If the loss tangent (tan δ) is 0.10 or more, the obtained grip has better anti-slipping performance.

The upper limit of the loss tangent (tan δ) is not particularly limited. The loss tangent (tan δ) is preferably 0.26 or less, more preferably 0.24 or less, and even more preferably 0.23 or less. If the loss tangent (tan δ) is 0.26 or less, excessive deflection of the cured product of the rubber composition can be controlled.

The complex elastic modulus (E*) at the temperature of 25° C. of the crosslinked rubber obtained by curing the rubber composition at the vulcanizing temperature of 185° C. is preferably 8.00 MPa or less, more preferably 7.90 MPa or less, and even more preferably 7.80 MPa or less, wherein the complex elastic modulus (E*) at the temperature of 25° C. is measured with the dynamic viscoelasticity measuring apparatus under measuring conditions of the oscillation frequency: 10 Hz, the strain amplitude: 0.05%, and the tensile mode. If the complex elastic modulus (E*) is 8.00 MPa or less, excessive hardening of the cured product of the rubber composition can be controlled.

The lower limit of the complex elastic modulus (E*) is not particularly limited. The complex elastic modulus (E*) is preferably 3.00 MPa or more, more preferably 3.20 MPa or more, and even more preferably 3.40 MPa or more. If the complex elastic modulus (E*) is 3.00 MPa or more, the hardness of the cured product of the rubber composition is more suitable for the grip.

The density of the crosslinked rubber obtained by curing the rubber composition at the vulcanizing temperature of 185° C. is preferably 1.05 g/cm³ or more, more preferably 1.06 g/cm³ or more, and even more preferably 1.07 g/cm³ or more, and is preferably 1.10 g/cm³ or less, more preferably 1.09 g/cm³ or less, and even more preferably 1.08 g/cm³ or less. If the density falls within the above range, the single layered grip formed from the rubber composition has a weight similar to the conventional grip, and thus can replace the conventional grip without problems.

The hardness (Shore A hardness) of the crosslinked rubber is preferably 52 or more, more preferably 53 or more, and even more preferably 54 or more, and is preferably 62 or less, more preferably 61 or less, and even more preferably 60 or less. If the hardness (Shore A hardness) of the crosslinked rubber is 52 or more, the grip has further enhanced mechanical strength, and if the hardness (Shore A hardness) of the crosslinked rubber is 62 or less, the grip is not excessively hard and thus the feeling when holding the grip is better.

The tensile strength at break (Tb) of the crosslinked rubber obtained by curing the rubber composition at the vulcanizing temperature of 185° C. is preferably 23 MPa or more, more preferably 24 MPa or more, and even more preferably 25 MPa or more. If the tensile strength at break is 23 MPa or more, the grip has better abrasion resistance. The upper limit of the tensile strength at break of the crosslinked rubber obtained by curing the rubber composition at the vulcanizing temperature of 185° C. is not particularly limited, and is generally 40 MPa.

The elongation at break (Eb) of the crosslinked rubber obtained by curing the rubber composition at the vulcanizing temperature of 185° C. is preferably 300% or more, more preferably 320% or more, and even more preferably 340% or more. If the elongation at break is 300% or more, occurrence of the problem that the grip is broken when inserting a shaft into the grip can be further suppressed. The upper limit of the elongation at break of the crosslinked rubber obtained by curing the rubber composition at the vulcanizing temperature of 185° C. is not particularly limited, and is generally 800%.

The grip rubber composition according to the present disclosure is used for forming a grip. The grip rubber composition has excellent abrasion resistance, tensile strength and friction coefficient after being cured, and thus is suitably used for a golf club grip.

### [Golf Club Grip]

The golf club grip according to the present disclosure comprises a cylindrical portion, wherein at least one part of the cylindrical portion is formed from the above grip rubber composition. In other words, at least one part of the cylindrical portion is composed of the crosslinked rubber obtained by vulcanizing the above grip rubber composition.

The golf club grip comprises the cylindrical portion for inserting a shaft. Examples of the structure of the cylindrical portion include a single layered structure, a dual layered structure, and a triple layered structure. When the cylindrical portion is single layered, the whole cylindrical portion is formed from the rubber composition. When the cylindrical portion is multiple layered, at least one layer is formed from the rubber composition. It is noted that when the cylindrical portion is multiple layered, at least the outermost layer is preferably formed from the rubber composition.

The cylindrical portion of the golf club grip is preferably single layered. Since the grip rubber composition can be vulcanized at a high temperature, even a thick member can be formed in a short time. Thus, if the grip rubber composition is used to produce the single layered cylindrical portion, the structure is simple, and the vulcanizing time can also be shortened, thus the productivity of the grip is further enhanced. In addition, if the crosslinked rubber formed from the rubber composition has a density in a range from 1.05 g/cm³ to 1.10 g/cm³, the single layered grip formed from the rubber composition has a weight similar to the conventional grip, and thus can replace the conventional grip without problems.

The cylindrical portion may be solid or porous. If the cylindrical portion is solid, the grip has a high mechanical strength, and if the cylindrical portion is porous, the grip may have a light weight.

The golf club grip may be obtained by molding the rubber composition in a mold. Examples of the molding method include a press molding method and an injection molding method. In addition, the golf club grip having an inner layer and an outer layer may be obtained, for example, by press molding a laminated product composed of an unvulcanized rubber sheet formed from an outer layer rubber composition and an unvulcanized rubber sheet formed from an inner layer rubber composition in a mold.

### [Golf Club]

The present invention also includes a golf club using the above golf club grip. The golf club comprises a shaft, a head provided on one end of the shaft, and a grip provided on another end of the shaft, wherein the grip is the golf club grip according to the present invention. The shaft can be made of stainless steel or a carbon fiber reinforced resin. Examples of the head include a wood type, a utility type, and an iron type. The material constituting the head is not particularly limited, and examples thereof include titanium, titanium alloy, carbon fiber reinforced plastic, stainless steel, maraging steel and soft iron.

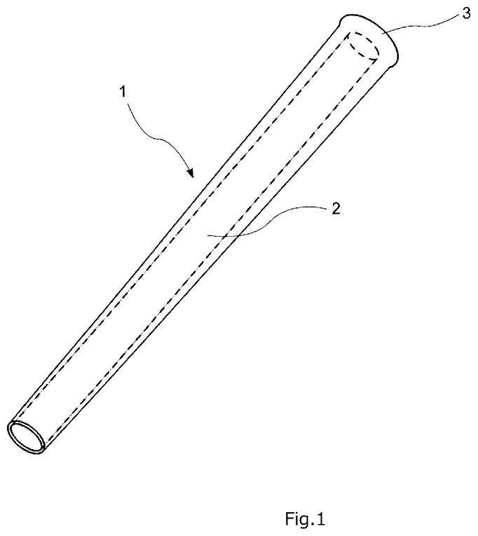

Next, the golf club grip and the golf club will be explained with reference to figures. FIG. 1 is a perspective view showing one example of the golf club grip. A grip 1 comprises a cylindrical portion 2 for inserting a shaft, and an integrally molded cap portion 3 for covering the opening of the back end of the cylindrical portion. The cylindrical portion 2 is single layered. The cylindrical portion 2 is formed with a thickness gradually becoming thicker from the front end toward the back end. In the grip 1 shown in FIG. 1, the cap portion 3 is formed from the same rubber composition as the cylindrical portion 2.

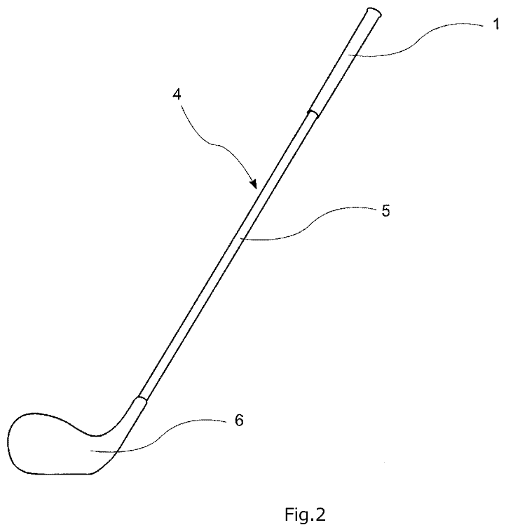

FIG. 2 is a perspective view showing one example of the golf club comprising the golf club grip according to the present disclosure. A golf club 4 comprises a shaft 5, a head 6 provided on one end of the shaft 5, and a grip 1 provided on another end of the shaft 5. The back end of the shaft 5 is inserted into the cylindrical portion 2 of the grip 1.

### EXAMPLES

Next, the present disclosure will be described in detail by way of examples. However, the present disclosure is not limited to the examples described below. Various changes and modifications without departing from the spirit of the present disclosure are included in the scope of the present disclosure.

### [Evaluation Method]

### (1) Amount of Acrylonitrile

The amount of the acrylonitrile in the acrylonitrile-butadiene rubber before hydrogenation was measured according to ISO 24698-1 (2008).

### (2) Amount of Double Bond (Mmol/g)

The amount of the double bond was calculated from the amount (mass %) of the butadiene in the copolymer and the amount (%) of the residual double bond. The amount of the residual double bond is a mass ratio (amount of the double bond after hydrogenation/amount of the double bond before hydrogenation) of the double bond in the copolymer after hydrogenation to the double bond in the copolymer before hydrogenation, and can be measured by infrared spectroscopy. When the acrylonitrile-butadiene rubber is the acrylonitrile-butadiene binary copolymer, the amount of the butadiene in the copolymer is calculated by subtracting the amount (mass %) of the acrylonitrile from 100.

Amount of double bond={amount of butadiene/54}×amount of residual double bond×10

### (3) Amount of Monomer Having a Carboxy Group

One gram of the hydrogenated acrylonitrile-butadiene rubber was weighed and dissolved in 50 mL of chloroform, and a thymol blue indicator was added therein dropwise. A methanol solution of 0.05 mol/L sodium hydroxide was added dropwise into the solution while the solution was stirred, and the addition amount (V mL) at the time the solution color initially changed was recorded. Regarding a blank, i.e. 50 mL of chloroform not containing the hydrogenated acrylonitrile-butadiene rubber, thymol blue was used as an indicator, a methanol solution of 0.05 mol/L sodium hydroxide was added dropwise into the solution, and the addition amount (B mL) at the time the solution color initially changed was recorded. The amount of the monomer having the carboxy group was calculated according to the following formula.

Amount of monomer having a carboxy group={0.05×(V−B)×PM}/(10×X)

(In the formula, V: addition amount (mL) of sodium hydroxide solution in test solution, B: addition amount (mL) of sodium hydroxide solution in blank, PM: molecular weight of monomer having a carboxy group, X: valence of monomer having a carboxy group)

### (2) Vulcanization Test

The vulcanization test for the rubber composition was conducted with a curemeter (CURELASTOMETER (registered trademark) Type 7 available from JSR Trading Co., Ltd.) at the vulcanizing temperature described in Tables 3 and 4. According to “9. Die vulcanization test method A” of “Determination of cure characteristics with oscillating curemeters” in JIS K6300-2(2001), a sinusoidal vibration with a low amplitude which does not break the rubber test piece was applied to the rubber test piece from the lower die, and the torque that traveled from the test piece to the upper die was measured in the period from the unvulcanized state to the over-vulcanized state. The measurement was conducted under conditions of a torsional frequency: 100 times per minute, an amplitude angle: 1°, and a measuring time: 30 minutes. The minimum value (ML) and maximum value (MH) of the torque, and the 90% vulcanizing time (t90) were obtained from the obtained vulcanization curve.

### (5) Hardness (Shore A Hardness)

Sheets with a thickness of 2 mm were produced by vulcanizing the rubber composition under the conditions described in Tables 3 and 4. The sheets were stored at a temperature of 23° C. for two weeks. At least three of these sheets were stacked on one another so as not to be affected by the measuring substrate on which the sheets were placed, and the hardness of the stack was measured with an automatic hardness tester (Digitest II, available from Bareiss company) using a testing device of “Shore A”.

(6) Density (g/cm³)

Square sheets with a side length of 13 cm and a thickness of 2 mm were produced by vulcanizing the rubber composition under the conditions described in Tables 3 and 4. The sheet was punched into a square with a side length of 2 cm to prepare a test piece. The density of the obtained test piece was measured with an automatic densimeter (SP-GR1 available from MS-technical, Inc., Archimedes' principle).

### (7) Tensile Strength at Break (MPa) and Elongation at Break (%)

The tensile strength at break and the elongation at break were measured according to JIS K 6251 (2017). Specifically, a sheet with a thickness of 1 mm was produced by vulcanizing the rubber composition under the conditions described in Tables 3 and 4, the sheet was punched into a dumbbell shape (Dumbbell shape No. 3) to prepare a test piece, and the properties of the test piece were measured under the conditions of a measurement temperature: 23° C. and a tensile speed: 500 mm/min with a tensile test measurement apparatus (Autograph (registered trademark) AGS-D available from Shimadzu Corporation). In addition, the tensile strength at break was calculated by dividing the tensile strength recorded when the test piece was broken by the cross-sectional area of the test piece before the test.

### (8) Viscoelastic Properties

The loss tangent (tan δ) and the complex elastic modulus (E*) were measured with a dynamic viscoelasticity measuring apparatus (Rheogel-E4000 available from UBM KK).

The test sample was produced by slicing the grip in the thickness direction to obtain a slice with a thickness of 1.6 mm, and punching the slice into a determined size. The measurement was performed under the conditions of a temperature range: −100° C. to 100° C., a temperature rising rate: 3° C./min, a measuring interval: 3° C., a frequency: 10 Hz, a strain amplitude: 10%, a jig: tensile mode, and a sample shape: width of 4 mm, thickness of 2 mm and length of 40 mm. The loss tangent (tan δ) and the complex elastic modulus (E*) at the temperature of 25° C. were determined based on the viscoelastic spectrum obtained by the dynamic viscoelasticity measurement.

### (9) Friction Coefficient

The friction coefficient was measured with a static/dynamic friction tester (Trilab master available from Trinity-Lab Inc.).

The test sample was produced by slicing the grip in the thickness direction to obtain a slice with a thickness of 1.6 mm, removing the groove pattern, and punching the slice into a size with a width of 10 mm and a length of 20 mm. The test sample was fixed on the planar contactor of the tester. In addition, a natural leather cut from the palm of a golf glove (XXIO (registered trademark) Golf glove (GGG-X008) available from Sumitomo rubber Industries, Ltd.) was fixed on the moving table.

The measurement was conducted under conditions of a load: 25 g, a moving speed: 1 mm/sec, and a moving distance: 10 mm, and the average value of the dynamic friction coefficient in the period between 2000 ms and 6000 ms from starting the measurement was calculated.

It is noted that the friction coefficient of the crosslinked rubber No. 6 was defined as 100, and the friction coefficient of each crosslinked rubber was represented by converting the friction coefficient of each crosslinked rubber into this index.

### [Preparation of Rubber Composition]

The rubber compositions were prepared by kneading the materials having the formulations shown in Tables 1 and 2. It is noted that all the materials of the rubber composition were kneaded with a sealed kneading machine.

TABLE 2

| Rubber composition No. | | | H | I | J | K | L | M | N |
|---|---|---|---|---|---|---|---|---|---|
| Formulation | Base rubber | HXNBR | 100 | 100 | 100 | 100 | 100 | 100 | 100 |
| (parts | Vulcanizing agent | Sulfur | 1.5 | 1.5 | 1.5 | 1.5 | 1.5 | 1.5 | 1.5 |
| by | Thiuram based | SANCELER TBzTD | 3.0 | 3.0 | 3.0 | 3.0 | 3.0 | 3.0 | 3.0 |
| mass) | accelerator | NOCCELER TOT-N | 3.0 | 3.0 | 3.0 | 3.0 | 3.0 | 3.0 | 3.0 |
| | Sulfenamide based | SANCELER NS | 1.0 | 1.0 | 1.0 | 1.0 | 1.0 | 1.0 | 1.0 |
| | accelerator | | | | | | | | |
| | Thiourea based | NOCCELER EUR | 0.5 | 0.5 | 0.5 | 0.5 | 0.5 | 0.5 | 0.5 |
| | accelerator | | | | | | | | |
| | Vulcanization | Zinc peroxide | 5 | 5 | 5 | 5 | 5 | 5 | 5 |
| | activator | | | | | | | | |
| | Resin | EVA | 30 | 30 | 30 | 30 | 30 | 30 | 30 |
| | Solid | Staybelite | — | — | 8 | 8 | — | — | — |
| | tackifier | Ester 10-E | | | | | | | |
| | Liquid | SYLVATAC | 8 | 16 | 8 | — | 8 | 8 | 8 |
| | tackifier | RE-5S | | | | | | | |
| | Reinforcing | Carbon black | — | — | — | — | 15 | 10 | 5 |
| | material | Silica | 32 | 33 | 33 | 13 | 15 | 20 | 25 |
| | | Calcium | — | — | — | 4 | — | — | — |
| | | carbonate | | | | | | | |
| | | Rutile type | 1 | 1 | 1 | 1 | — | — | — |
| | | titanium oxide | | | | | | | |
| | Lubricant | vanfre VAM | 0.25 | 0.25 | 0.25 | 0.25 | 0.25 | 0.25 | 0.25 |

| | | | | | | | |
|---|---|---|---|---|---|---|---|
| Amount of thiuram based accelerator (parts by mass) | 6.0 | 6.0 | 6.0 | 6.0 | 6.0 | 6.0 | 6.0 |
| with respect to 100 parts by mass of base rubber | | | | | | | |
| Amount of sulfenamide based accelerator (parts by mass) | 1.0 | 1.0 | 1.0 | 1.0 | 1.0 | 1.0 | 1.0 |
| with respect to 100 parts by mass of base rubber | | | | | | | |
| Amount of thiourea based accelerator (parts by mass) | 0.5 | 0.5 | 0.5 | 0.5 | 0.5 | 0.5 | 0.5 |
| with respect to 100 parts by mass of base rubber | | | | | | | |

The materials used in Tables 1 and 2 are shown as follows.
HXNBR: hydrogenated carboxy-modified acrylonitrile-butadiene rubber (Therban XT VPKA 8889 (amount of residual double bond: 3.5%, amount of acrylonitrile: 33.0 mass %, amount of double bond: 0.40 mmol/g, amount of monomer having a carboxy group: 5.0 mass % available from ARANXEO Corporation)
Sulfur: 5% oil treated sulfur fine powder (200 mesh) available from Tsurumi Chemical Industry Co., Ltd.
SANCELER (registered trademark) TBzTD: tetrabenzylthiuram disulfide available from Sanshin Chemical Industry Co., Ltd.
NOCCELER (registered trademark) TOT-N: tetrakis(2-ethylhexyl)thiuram disulfide available from Ouchi Shinko Chemical Industrial Co., Ltd.
NOCCELER EUR: N,N′-diethyl thiourea available from Ouchi Shinko Chemical Industrial Co., Ltd.
SANCELER NS: N-(tert-butyl)-2-benzothiazole sulfenamide available from Sanshin Chemical Industry Co., Ltd.
NOCCELER EUR: N,N′-diethyl thiourea available from Ouchi Shinko Chemical Industrial Co., Ltd.
Zinc peroxide: Struktol ZP 1014 (amount of zinc peroxide: 29 mass %) available from Struktol Corporation
EVA: ethylene-vinyl acetate copolymer (Levapren 500 (amount of vinyl acetate: 50 mass %, Mooney viscosity (ML₁₊₄ (100° C.)): 27) available from ARANXEO Corporation)
Staybelite Ester 10-E: partially hydrogenated rosin ester available from Eastman Chemical Company
SYLVATAC RE-5S: rosin ester (melting point: 25° C. or less) available from Arizona Chemical Corporation
Carbon black: SEAST (registered trademark) 3 (specific surface area: 79 m²/g) available from Tokai Carbon Co., Ltd.
Silica: Nipsil (registered trademark) VN3 (specific surface area: 180 to 230 m²/g) available from Tosoh Corporation
Calcium carbonate: SOFTON 3200 (specific surface area: 3.2 m²/g) available from Shiraishi Calcium Corporation
Rutile type titanium oxide: CR60 available from Ishihara Sangyo Kaisha, Ltd.
vanfre VAM: polyoxyethylene-octadecyl ether-phosphoric acid available from Vanderbilt Chemicals LLC

### [Production of Grip]

The rubber compositions were charged into a mold having a groove pattern on the cavity surface thereof. Then, vulcanization was carried out under the conditions described in Table 2 to conduct a crosslinking reaction in the rubber, thereby obtaining golf club grips. The viscoelastic properties and friction coefficient of the grips were evaluated, and the results are shown in Tables 3 and 4.

TABLE 3

| | | | Crosslinked rubber No. | | | | | | | |
|---|---|---|---|---|---|---|---|---|---|---|
| | | | 1 | 2 | 3 | 4 | 5 | 6 | 7 | 8 |
| Used rubber composition No. | | | B | C | D | E | A | F | G | G |
| Vulcanization | Vulcanizing temperature (° C.) | | 185 | 185 | 185 | 185 | 185 | 185 | 165 | 185 |
| test | t90 (min) | | 3.3 | 3.3 | 3.3 | 3.2 | 3.3 | 3.6 | 11 | 3.5 |
| Properties | Vulcanizing | Vulcanizing | 185 | 185 | 185 | 185 | 185 | 185 | 165 | 185 |
| of | condition | temperature (° C.) | | | | | | | | |
| crosslinked | | Vulcanizing | 5 | 5 | 5 | 5 | 5 | 6 | 13 | 6 |
| rubber | | time (min) | | | | | | | | |
| | Density (g/cm³) | | 1.08 | 1.08 | 1.07 | 1.07 | 1.08 | 1.04 | 1.05 | 1.08 |
| | Hardness (Shore A) | | 54 | 54 | 56 | 55 | 55 | 50 | 56 | 57 |
| | Tensile strength at | | 30 | 24 | 28 | 28 | 25 | 25 | 27 | 21 |
| | break Tb (MPa) | | | | | | | | | |
| | Elongation at break Eb (%) | | 525 | 511 | 494 | 558 | 502 | 571 | 585 | 540 |
| Properties | Vulcanizing | Vulcanizing | 185 | 185 | 185 | 185 | 185 | 185 | 165 | 185 |
| of | condition | temperature (° C.) | | | | | | | | |
| grips | | Vulcanizing | 5 | 5 | 5 | 5 | 5 | 6 | 13 | 6 |
| | | time (min) | | | | | | | | |
| | Visco | Complex elastic | 4.61 | 5.29 | 5.49 | 5.58 | 4.32 | 4.56 | 4.87 | 4.92 |
| | elasticity | modulus E* (MPa) | | | | | | | | |
| | | Loss tangent | 0.195 | 0.217 | 0.234 | 0.236 | 0.249 | 0.240 | 0.204 | 0.201 |
| | | tanδ | | | | | | | | |
| | | Ratio (tanδ/E*) | 0.042 | 0.041 | 0.043 | 0.042 | 0.058 | 0.053 | 0.042 | 0.041 |

| | | | | | | | | |
|---|---|---|---|---|---|---|---|---|
| Friction coefficient | 107 | 106 | 108 | 113 | 97 | 100 | — | — |

TABLE 4

| | | | Crosslinked rubber No. | | | | | | |
|---|---|---|---|---|---|---|---|---|---|
| | | | 9 | 10 | 11 | 12 | 13 | 14 | 15 |
| Used rubber composition No. | | | H | I | J | K | L | M | N |
| Vulcanization | Vulcanizing temperature (° C.) | | 185 | 185 | 185 | 185 | 185 | 185 | 185 |
| test | t90 (min) | | 3.3 | 3.1 | 3.1 | 3.5 | 3.0 | 3.0 | 2.8 |
| Properties | Vulcanizing | Vulcanizing | 185 | 185 | 185 | 185 | 185 | 185 | 185 |
| of | condition | temperature (° C.) | | | | | | | |
| crosslinked | | Vulcanizing | 5 | 5 | 5 | 6 | 5 | 5 | 5 |
| rubber | | time (min) | | | | | | | |
| | Density (g/cm³) | | 1.10 | 1.10 | 1.10 | 1.06 | 1.09 | 1.08 | 1.09 |
| | Hardness (Shore A) | | 60 | 57 | 62 | 52 | 59 | 61 | 61 |
| | Tensile strength at | | 31 | 27 | 29 | 24 | 32 | 29 | 32 |
| | break Tb (MPa) | | | | | | | | |
| | Elongation at break Eb (%) | | 579 | 577 | 573 | 583 | 554 | 531 | 552 |
| Properties | Vulcanizing | Vulcanizing | 185 | 185 | 185 | 185 | 185 | 185 | 185 |
| of | condition | temperature (° C.) | | | | | | | |
| grips | | Vulcanizing | 5 | 5 | 5 | 6 | 5 | 5 | 5 |
| | | time (min) | | | | | | | |
| | Visco | Complex elastic | 9.39 | 9.73 | 8.53 | 5.59 | 7.14 | 7.48 | 7.82 |
| | elasticity | modulus E* (MPa) | | | | | | | |
| | | Loss tangent | 0.206 | 0.203 | 0.217 | 0.277 | 0.213 | 0.208 | 0.216 |
| | | tanδ | | | | | | | |
| | | Ratio (tanδ/E*) | 0.022 | 0.021 | 0.025 | 0.049 | 0.030 | 0.028 | 0.028 |

| | | | | | | | |
|---|---|---|---|---|---|---|---|
| Friction coefficient | 79 | 88 | 92 | 101 | 105 | 104 | 103 |

The crosslinked rubbers No. 1 to 6 and 9 to 15 were formed from the rubber compositions No. A to F and H to N.

The rubber compositions No. A to F and H to N comprise the thiuram based vulcanization accelerator, the sulfenamide based vulcanization accelerator, and the thiourea based vulcanization accelerator in the predetermined amount respectively, as the vulcanization accelerator. The 90% vulcanizing time of these rubber compositions No. A to F and H to N at the vulcanizing temperature of 185° C. is 3.6 minutes or less, and thus the vulcanizing speed is fast. In addition, the crosslinked rubbers No. 1 to 6 and 9 to 15 obtained by vulcanizing these rubber compositions No. A to F and H to N at the vulcanizing temperature of 185° C. have the tensile strength at break of 24 MPa or more, and thus are excellent in the mechanical property.

Further, the ratio (tan δ/E*) of the loss coefficient (tan δ) to the complex elastic modulus (E*) (MPa) at the temperature of 25° C. of the grips (crosslinked rubbers) obtained by vulcanizing the rubber compositions No. B to E and K to N at the vulcanizing temperature of 185° C. range from 0.027 to 0.052. Thus, the grips formed from the rubber compositions No. B to E and K to N are excellent in the friction coefficient.

On the contrary, the ratio (tan δ/E*) of the loss coefficient (tan δ) to the complex elastic modulus (E*) (MPa) at the temperature of 25° C. of the grips (crosslinked rubbers) obtained by vulcanizing the rubber compositions No. A and F are more than 0.052. Thus, the grips formed from the rubber compositions No. A and F are inferior in the friction coefficient

In addition, the ratio (tan δ/E*) of the loss coefficient (tan δ) to the complex elastic modulus (E*) (MPa) at the temperature of 25° C. of the grips (crosslinked rubbers) obtained by vulcanizing the rubber compositions No. H to J are less than 0.027. Thus, the grips formed from the rubber compositions No. H to J are inferior in the friction coefficient

The crosslinked rubbers No. 7 and 8 were formed from the rubber composition No. G.

The rubber composition No. G comprises the thiuram based vulcanization accelerator and the sulfenamide based vulcanization accelerator as the vulcanization accelerator, and does not comprise the thiourea based vulcanization accelerator. The crosslinked rubber No. 7 obtained by vulcanizing the rubber composition No. G at the vulcanizing temperature of 165° C. has the tensile strength at break of 27 MPa or more, and thus is excellent in the mechanical property. However, the 90% vulcanizing time of the rubber composition No. G at the vulcanizing temperature of 165° C. is 11 min, and thus a long time was necessary for the vulcanization. In addition, the 90% vulcanizing time of the rubber composition No. G at the vulcanizing temperature of 185° C. is 3.5 min, and thus the vulcanizing speed is fast. However, the crosslinked rubber No. 8 obtained by vulcanizing the rubber composition No. G at the vulcanizing temperature of 185° C. has the tensile strength at break of 21 MPa, and thus is inferior in the mechanical property.

The present disclosure (1) is a grip rubber composition comprising a base rubber, a vulcanizing agent and a vulcanization accelerator, wherein the base rubber contains a hydrogenated carboxy-modified acrylonitrile-butadiene rubber, the vulcanization accelerator contains a thiuram based vulcanization accelerator, a sulfenamide based vulcanization accelerator, and a thiourea based vulcanization accelerator, an amount of the thiuram based vulcanization accelerator is 4 parts by mass or more with respect to 100 parts by mass of the base rubber, an amount of the sulfenamide based vulcanization accelerator is 0.3 part by mass or more with respect to 100 parts by mass of the base rubber, an amount of the thiourea based vulcanization accelerator is 0.1 part by mass or more with respect to 100 parts by mass of the base rubber, and a crosslinked rubber obtained by curing the grip rubber composition at a vulcanizing temperature of 185° C. has a loss coefficient (tan δ) and a complex elastic modulus (E*) (MPa) at a temperature of 25° C. in a ratio (tan δ/E*) ranging from 0.027 to 0.052, wherein the loss coefficient (tan δ) and the complex elastic modulus (E*) (MPa) at the temperature of 25° C. are measured with a dynamic viscoelasticity measuring apparatus under measuring conditions of an oscillation frequency: 10 Hz, a strain amplitude: 0.05%, and a tensile mode.

The present disclosure (2) is the grip rubber composition according to the present disclosure (1), wherein the grip rubber composition has a 90% vulcanizing time (t90) of 5 minutes or less on a vulcanization curve measured at a vulcanizing temperature of 185° C.

The present disclosure (3) is the grip rubber composition according to the present disclosure (1) or (2), wherein the crosslinked rubber obtained by curing the grip rubber composition at the vulcanizing temperature of 185° C. has a tensile strength at break of 23 MPa or more.

The present disclosure (4) is the grip rubber composition according to any one of the present disclosures (1) to (3), wherein the crosslinked rubber obtained by curing the grip rubber composition at the vulcanizing temperature of 185° C. has a density ranging from 1.05 g/cm³ to 1.10 g/cm³.

The present disclosure (5) is the grip rubber composition according to any one of the present disclosures (1) to (4), wherein the crosslinked rubber obtained by curing the grip rubber composition at the vulcanizing temperature of 185° C. has a hardness ranging from 52 to 62 in Shore A hardness.

The present disclosure (6) is a golf club grip comprising a cylindrical portion, wherein at least one part of the cylindrical portion is formed from the grip rubber composition according to any one of the present disclosures (1) to (5). This application is based on Japanese patent application No. 2024-007416 filed on Jan. 22, 2024, the content of which is hereby incorporated by reference.

1. A grip rubber composition comprising a base rubber, a vulcanizing agent and a vulcanization accelerator, wherein
the base rubber contains a hydrogenated carboxy-modified acrylonitrile-butadiene rubber,
the vulcanization accelerator contains a thiuram based vulcanization accelerator, a sulfenamide based vulcanization accelerator, and a thiourea based vulcanization accelerator,
an amount of the thiuram based vulcanization accelerator is 4 parts by mass or more with respect to 100 parts by mass of the base rubber,
an amount of the sulfenamide based vulcanization accelerator is 0.3 part by mass or more with respect to 100 parts by mass of the base rubber,
an amount of the thiourea based vulcanization accelerator is 0.1 part by mass or more with respect to 100 parts by mass of the base rubber, and
a crosslinked rubber obtained by curing the grip rubber composition at a vulcanizing temperature of 185° C. has a loss coefficient (tan δ) and a complex elastic modulus (E*) (MPa) at a temperature of 25° C. in a ratio (tan δ/E*) ranging from 0.027 to 0.052, wherein the loss coefficient (tan δ) and the complex elastic modulus (E*) (MPa) at the temperature of 25° C. are measured with a dynamic viscoelasticity measuring apparatus under measuring conditions of an oscillation frequency: 10 Hz, a strain amplitude: 0.05%, and a tensile mode.

2. The grip rubber composition according to claim 1, wherein the grip rubber composition has a 90% vulcanizing time (t90) of 5 minutes or less on a vulcanization curve measured at a vulcanizing temperature of 185° C.

3. The grip rubber composition according to claim 1, wherein the crosslinked rubber obtained by curing the grip rubber composition at the vulcanizing temperature of 185° C. has a tensile strength at break of 23 MPa or more.

4. The grip rubber composition according to claim 1, wherein the crosslinked rubber obtained by curing the grip rubber composition at the vulcanizing temperature of 185° C. has a density ranging from 1.05 g/cm³ to 1.10 g/cm³.

5. The grip rubber composition according to claim 1, wherein the crosslinked rubber obtained by curing the grip rubber composition at the vulcanizing temperature of 185° C. has a hardness ranging from 52 to 62 in Shore A hardness.

6. The grip rubber composition according to claim 1, wherein a total amount of the thiuram based vulcanization accelerator, the sulfenamide based vulcanization accelerator and the thiourea based vulcanization accelerator ranges from 4.4 parts by mass to 12.5 parts by mass with respect to 100 parts by mass of the base rubber.

7. The grip rubber composition according to claim 1, wherein a mass ratio (thiuram based vulcanization accelerator/sulfenamide based vulcanization accelerator) of the thiuram based vulcanization accelerator to the sulfenamide based vulcanization accelerator ranges from 1.5 to 30.

8. The grip rubber composition according to claim 1, wherein a mass ratio (thiuram based vulcanization accelerator/thiourea based vulcanization accelerator) of the thiuram based vulcanization accelerator to the thiourea based vulcanization accelerator ranges from 4 to 20.

9. The grip rubber composition according to claim 1, wherein the loss coefficient (tan δ) at the temperature of 25° C. of the crosslinked rubber ranges from 0.10 to 0.26.

10. The grip rubber composition according to claim 1, wherein the complex elastic modulus (E*) at the temperature of 25° C. of the crosslinked rubber ranges from 3.00 MPa to 8.00 MPa.

11. A golf club grip comprising a cylindrical portion, wherein at least one part of the cylindrical portion is formed from a grip rubber composition,
the grip rubber composition comprises a base rubber, a vulcanizing agent and a vulcanization accelerator,
the base rubber contains a hydrogenated carboxy-modified acrylonitrile-butadiene rubber,
the vulcanization accelerator contains a thiuram based vulcanization accelerator, a sulfenamide based vulcanization accelerator, and a thiourea based vulcanization accelerator,
an amount of the thiuram based vulcanization accelerator is 4 parts by mass or more with respect to 100 parts by mass of the base rubber,
an amount of the sulfenamide based vulcanization accelerator is 0.3 part by mass or more with respect to 100 parts by mass of the base rubber,
an amount of the thiourea based vulcanization accelerator is 0.1 part by mass or more with respect to 100 parts by mass of the base rubber, and
a crosslinked rubber obtained by curing the grip rubber composition at a vulcanizing temperature of 185° C. has a loss coefficient (tan δ) and a complex elastic modulus (E*) (MPa) at a temperature of 25° C. in a ratio (tan δ/E*) ranging from 0.027 to 0.052, wherein the loss coefficient (tan δ) and the complex elastic modulus (E*) (MPa) at the temperature of 25° C. are measured with a dynamic viscoelasticity measuring apparatus under measuring conditions of an oscillation frequency: 10 Hz, a strain amplitude: 0.05%, and a tensile mode.

12. The golf club grip according to claim 11, wherein the grip rubber composition has a 90% vulcanizing time (t90) of 5 minutes or less on a vulcanization curve measured at a vulcanizing temperature of 185° C.

13. The golf club grip according to claim 11, wherein the crosslinked rubber obtained by curing the grip rubber composition at the vulcanizing temperature of 185° C. has a tensile strength at break of 23 MPa or more.

14. The golf club grip according to claim 11, wherein the crosslinked rubber obtained by curing the grip rubber composition at the vulcanizing temperature of 185° C. has a density ranging from 1.05 g/cm³ to 1.10 g/cm³.

15. The golf club grip according to claim 11, wherein the crosslinked rubber obtained by curing the grip rubber composition at the vulcanizing temperature of 185° C. has a hardness ranging from 52 to 62 in Shore A hardness.

16. The golf club grip according to claim 11, wherein a total amount of the thiuram based vulcanization accelerator, the sulfenamide based vulcanization accelerator and the thiourea based vulcanization accelerator ranges from 4.4 parts by mass to 12.5 parts by mass with respect to 100 parts by mass of the base rubber.

17. The golf club grip according to claim 11, wherein a mass ratio (thiuram based vulcanization accelerator/sulfenamide based vulcanization accelerator) of the thiuram based vulcanization accelerator to the sulfenamide based vulcanization accelerator ranges from 1.5 to 30.

18. The golf club grip according to claim 11, wherein a mass ratio (thiuram based vulcanization accelerator/thiourea based vulcanization accelerator) of the thiuram based vulcanization accelerator to the thiourea based vulcanization accelerator ranges from 4 to 20.

19. The golf club grip according to claim 11, wherein the loss coefficient (tan δ) at the temperature of 25° C. of the crosslinked rubber ranges from 0.10 to 0.26.

20. The golf club grip according to claim 11, wherein the complex elastic modulus (E*) at the temperature of 25° C. of the crosslinked rubber ranges from 3.00 MPa to 8.00 MPa.
